(19) United States
(12) Patent Application Publication
(10) Pub. No.: US 2026/0115650 A1
(43) Pub. Date: Apr. 30, 2026

(54) HIGHLY CO2-SELECTIVE ASYMMETRIC POLYMERIC MEMBRANES AND PROCESS FOR PREPARING THE SAME

(71) Applicant: Sogang University Research & Business Development Foundation, Seoul (KR)

(72) Inventors: Jong Suk LEE, Seoul (KR); Mun Suk Seong, Seoul (KR); Ju Ho Shin, Seoul (KR)

(73) Assignee: Sogang University Research & Business Development Foundation, Seoul (KR)

(21) Appl. No.: 19/431,367

(22) Filed: Dec. 23, 2025

(30) Foreign Application Priority Data
Oct. 28, 2024 (KR) 10-2024-0148891

(51) Int. Cl. B01D 53/22; B01D 67/00; B01D 69/08; B01D 69/10; B01D 71/52; B01D 71/56; B01D 71/70

(52) U.S. Cl. CPC B01D 53/228; B01D 67/0006; B01D 67/0095; B01D 69/08; B01D 69/107; B01D 71/5211; B01D 71/56; B01D 71/701; B01D 2257/504; B01D 2323/02; B01D 2323/16; B01D 2323/30; B01D 2325/04; B01D 2325/36

(57) ABSTRACT

The present invention, in preparing a medicinal Platycodon root powder, (i) decomposes the cell wall by enzyme treatment, (ii) forms an antimicrobial and moisture-protective layer through coating with grapefruit seed extract and fructooligosaccharide, and (iii) recovers and concentrates residual saponins through low-temperature extraction and re-mixing, thereby providing a powder having high saponin and flavonoid contents and excellent storage stability without high-heat processing. This powder has high utility as a material for medicinal Platycodon root syrup, powdered beverages, and health functional food ingredients.

### CROSS REFERENCE TO RELATED APPLICATIONS

This application claims priority to and the benefit of Korean Patent Application No. 10-2024-0148891, filed on Oct. 28, 2024, the entire contents of each of which are hereby incorporated by reference.

### TECHNICAL FIELD

The present invention relates to an asymmetric polymer separation membrane having high selectivity for carbon dioxide and a method for manufacturing the same. In particular, the present invention relates to an asymmetric polymer separation membrane comprising a porous polymer support layer, a hydrophilic polydimethylsiloxane intermediate layer, and a selective layer composed of a polyether block amide and a polyether.

### BACKGROUND ART

Efforts for the reduction of carbon dioxide, which has a great influence on global warming, are continuing, and among various carbon dioxide capture technologies, membrane technology is receiving much attention due to its excellent space efficiency and energy efficiency. In particular, gas separation membranes, unlike separation technologies based on thermal energy, have an advantage in that energy consumption can be relatively reduced through a separation process that does not accompany a phase change. In order to efficiently separate a large amount of gas, an asymmetric separation membrane is mainly used, and it is manufactured in a form in which a thin selective separation layer is coated on a porous support. The asymmetric separation membrane is classified into a flat sheet type, a spiral wound type, and a hollow fiber type, and among these, the hollow fiber separation membrane is industrially advantageous in that it provides a larger surface area per unit volume.

A representative method for forming a selective layer on a hollow fiber-type support is a coating process. In order to minimize permeance loss caused by penetration of the selective layer coating solution into the inside of the support, an intermediate layer (gutter layer) is coated using a material having higher permeability than the selective layer, and the selective layer is coated thereon. As the intermediate layer, poly(1-trimethylsilyl-1-propyne) (PTMSP) and polydimethylsiloxane (PDMS) are generally used, but PTMSP has a problem in that gas permeability decreases as the free volume of the polymer decreases over time. PDMS, due to its hydrophobic characteristics, has poor wettability with a hydrophilic support and the selective layer, and thus there is a possibility that the selective layer may be peeled off. In order to solve this, a prior study has proposed a method in which PDMS is spin-coated on a flat-sheet support, then modified to be hydrophilic through O₂ plasma, and polyether-block amide copolymer (Pebax® 1657) is coated thereon as a selective layer. However, the hydrophilic modification method through O₂ plasma treatment has a problem in that hydrophilicity decreases over time (see ACS Appl. Mater. Interfaces, 2020, 12, 33196-33209). In addition, although a selective layer can be formed on the outer side of a hollow fiber membrane by a dip-coating method, this coating method has a problem in that the selective layer may be damaged during module fabrication because the selective layer is formed on the outer side of the hollow fiber-type support.

### PRIOR ART DOCUMENTS

### Non-Patent Documents

(Non-Patent Document 1) ACS Appl. Mater. Interfaces, 2020, 12, 33196-33209

### DISCLOSURE OF THE INVENTION

### Technical Problem

An object of the present invention is to provide an asymmetric polymer separation membrane having high selectivity for carbon dioxide and a method for manufacturing the same.

### Technical Solution

The above object of the present invention is achieved by an asymmetric polymer separation membrane having high selectivity for carbon dioxide, comprising: a porous polymer support layer; an intermediate layer formed on the porous polymer support layer; and a selective layer formed on a surface of the intermediate layer, wherein the intermediate layer is modified to be hydrophilic, and the selective layer is hydrophilic.

The intermediate layer may be crosslinked with a polyethylene-based oligomer containing a vinyl group and PDMS.

The polyethylene-based oligomer may include poly(ethylene glycol) methyl ether acrylate.

In the intermediate layer, the content of the polyethylene-based oligomer may be 14 to 20% by weight.

The intermediate layer may be obtained through a crosslinking reaction after being swollen by a first swelling agent comprising at least one selected from ethanol, methanol, and hexane with respect to the intermediate coating layer.

The free volume ratio of the intermediate layer is 0.18 to 0.3, and the contact angle of the intermediate layer may be 50 to 70 degrees.

The porous polymer support layer has a hollow, the intermediate layer and the selective layer are formed on an inner surface of the hollow, and the carbon dioxide permeability of the intermediate layer may be 168±37 GPU, the carbon dioxide/nitrogen selectivity may be 8.7±0.8, and the carbon dioxide/oxygen selectivity may be 4.4±0.4, 4.4±1.0 or 4.4±0.2.

The selective layer, based on the total weight of components (A) and (B), may include (A) 30 to 90% by weight of a polyether-based copolymer; and (B) 10 to 70% by weight of a polyether.

The polyether-based copolymer includes polyetheramide, and the polyether-based copolymer may include a polyethylene-based oligomer containing a vinyl group.

The polyether-based copolymer (A) may act as a matrix, and the polyether (B) may act as a dispersed phase.

The selective layer may be obtained through a crosslinking reaction after being swollen by a second swelling agent comprising ethanol with respect to the intermediate coating layer.

The porous polymer support layer has a hollow, the intermediate layer and the selective layer are formed on an inner surface of the hollow, and the carbon dioxide permeability of the separation membrane may be 138±34GPU, the carbon dioxide/nitrogen selectivity may be 23.4±4.1, and the carbon dioxide/oxygen selectivity may be 13.1±1.8.

The porous polymer support layer is in a flat-sheet form, the intermediate layer and the selective layer are formed on at least one surface of the porous polymer support layer, the carbon dioxide permeability of the intermediate layer may be 286±20 GPU, the carbon dioxide/nitrogen selectivity may be 29.8±4.0, and the carbon dioxide/oxygen selectivity may be 14.3±2.0.

Another object of the present invention, in a method for producing an asymmetric polymer separation membrane having high selectivity for carbon dioxide, is achieved by comprising: a step of forming an intermediate layer on a porous polymer support layer; and a step of forming a selective layer on the intermediate layer, wherein the intermediate layer is modified to be hydrophilic and the selective layer is hydrophilic.

The intermediate layer is formed by crosslinking a polyethylene-based oligomer and PDMS, and the formation of the intermediate layer may include: a step of preparing a mixture by mixing a curing agent containing a hydrosilyl group and the polyethylene-based oligomer, and preparing a first coating solution by adding a main agent containing a vinyl group to the mixture; a step of preparing a first coating layer by coating the first coating solution on an inner surface of the hollow; and a step of crosslinking the first coating layer.

The polyethylene-based oligomer may include poly(ethylene glycol) methyl ether acrylate.

In the intermediate layer, the content of the polyethylene-based oligomer may be 14 to 20% by weight.

The curing agent includes divinyl-terminated polydimethylsiloxane, and the curing agent may include a dimethyl, methyl hydrogen siloxane.

The method may further include a step of swelling the first coating layer using a first swelling agent including at least one of ethanol, methanol and hexane, and the crosslinking may be performed after the swelling.

The first swelling agent includes hexane, and the first swelling agent may be supplied to the first coating layer in a state saturated with air.

The selective layer, based on the total weight of components (A) and (B), may include (A) 30 to 90% by weight of a polyether-based copolymer; and (B) 10 to 70% by weight of a polyether.

The polyether-based copolymer includes polyetheramide, and the polyether-based copolymer includes a polyethylene-based oligomer containing a vinyl group, and the formation of the selective layer may include a step of preparing a second coating solution by mixing the polyetheramide and the polyethylene-based oligomer; a step of preparing a second coating layer by coating the second coating solution on the intermediate layer; and a step of crosslinking the second coating layer.

The method may further include a step of swelling the second coating layer using a second swelling agent including ethanol, and the crosslinking may be performed after the swelling.

Another object of the present invention is achieved by a method for separating a gas, the method comprising a step of passing a mixed gas comprising at least carbon dioxide through the separation membrane to remove at least a portion of the carbon dioxide.

The mixed gas may be selected from the group consisting of carbon dioxide/nitrogen, carbon dioxide/carbon monoxide, carbon dioxide/oxygen, carbon dioxide/methane, and carbon dioxide/hydrogen.

### Advantageous Effects

According to the present invention, an asymmetric polymer separation membrane having high selectivity for carbon dioxide and a method for manufacturing the same are provided.

### BRIEF DESCRIPTION OF THE DRAWINGS

FIG. 1 is a schematic diagram of the synthesis of PDMS-PEG according to the present invention.

FIG. 2 is a scanning electron microscope (SEM) image of the polyetherimide (PEI) porous hollow fiber support used in the present invention.

FIG. 3 is a graph showing Fourier-transform infrared spectroscopy (FT-IR) of PDMS and PDMS-PEG prepared according to the Examples.

FIG. 4 is a graph showing the proton nuclear magnetic resonance (1H-NMR) spectrum of a PDMS cross-linker and PDMS-PEG prepared according to the Examples.

FIG. 5 is a graph showing X-ray photoelectron spectroscopy (XPS) of PDMS and PDMS-PEG prepared according to the Examples.

FIG. 6 is the water contact angle of PDMS and PDMS-PEG separation membranes prepared according to the Examples.

FIG. 7 is an image showing the difference in wettability with Pebax-PPEGMEA according to the amount of PEG introduced into the PDMS-PEG intermediate layer prepared according to the Examples.

FIG. 8 is a graph showing the density and fractional free volume (FFV) of PDMS and PDMS-PEG separation membranes prepared according to the Examples.

FIG. 9 is a graph showing the solubility of PDMS-PEG prepared according to the Examples in two kinds of solvents and a ternary phase diagram thereof.

FIG. 10 is a graph for gas permeability and selectivity of PDMS and PDMS-PEG separation membranes prepared according to the Examples under single gas conditions.

FIG. 11 is a scanning electron microscope (SEM) image of hollow fiber membranes in which an intermediate layer is coated according to the PDMS-PEG concentration prepared according to the Examples.

FIG. 12 is a scanning electron microscope (SEM) image of a hollow fiber membrane in which a PDMS-PEG intermediate layer and a Pebax-PPEGMEA selective layer prepared according to the Examples are coated.

FIG. 13 is an image of (a) a flat-sheet PEI support and a PDMS-PEG intermediate layer prepared according to the Examples, and (b) a flat-sheet asymmetric polymer separation membrane on which a Pebax-PPEGMEA selective layer is coated.

FIG. 14 is a scanning electron microscope (SEM) image of a hollow fiber membrane on which a PDMS intermediate layer and a Pebax-PPEGMEA selective layer prepared according to the Examples are coated.

### MODE FOR CARRYING OUT THE INVENTION

Hereinafter, the present invention will be described in more detail.

In the present invention, a hydrophilic intermediate layer material is developed, and a highly permeable, defect-free hydrophilic intermediate layer is coated on a surface of a porous polymer support by using a swelling phenomenon by a solvent. Through this, by improving the wettability of a hydrophilic selective layer with respect to the intermediate layer, an asymmetric polymer separation membrane having high selectivity for carbon dioxide is provided. In addition, a method for producing a highly permeable intermediate layer and selective layer coating in which defects are greatly reduced or absent is provided by a swelling phenomenon by a solvent.

Without being limited thereto, the present invention provides an intermediate layer coating material including PDMS and poly(ethylene glycol) methyl ether acrylate (poly(ethylene glycol) methyl ether acrylate; PEGMEA). In addition, the present invention provides an asymmetric polymer separation membrane which is selective for carbon dioxide and includes a selective layer in which Pebax® 1657 and PEGMEA are mixed.

The porous polymer support may be in the form of a hollow fiber membrane or in the form of a flat sheet (including a flat membrane). When the porous polymer support is in the form of a hollow fiber membrane, the intermediate layer and the selective layer may be formed on an inner surface of the hollow of the hollow fiber membrane, and the asymmetric polymer separation membrane may also be referred to as a “polymer hollow fiber membrane.” When the porous polymer support is in the form of a flat sheet, the intermediate layer and the selective layer may be formed on one surface of the flat sheet.

Hereinafter, the case where the porous polymer support is in the form of a hollow fiber membrane will mainly be described by way of example.

The method for producing a polymer hollow fiber membrane according to the present invention is largely composed of formation of an intermediate layer and formation of a selective layer. The intermediate layer is modified to be hydrophilic, and the selective layer has hydrophilicity.

In the formation of the intermediate layer, first, a first coating layer is formed on an inner surface of the hollow of a porous polymer support layer having a hollow.

Thereafter, the first coating layer is swollen. In the swelling, the first coating layer is swollen by applying, to the first coating layer, a first swelling agent including at least one of ethanol, methanol and hexane. The first swelling agent may particularly include hexane, and may be supplied to the first coating layer in a state containing air or saturated with air.

The swelling may be carried out, without being limited thereto, at 10° C. to 30° C. or at room temperature, for 1 hour to 30 hours.

After the swelling, crosslinking of the swollen first coating layer is carried out. In the crosslinking, drying is also performed. Through the crosslinking, the intermediate layer is formed.

The crosslinking may be performed at 70° C. to 90° C. for 5 hours to 24 hours.

The intermediate layer may be such that a polyethylene-based oligomer and PDMS are crosslinked. The first coating solution may be prepared by preparing a mixture by mixing a curing agent containing a hydrosilyl group and a polyethylene-based oligomer, and adding a main agent containing a vinyl group to the mixture. The mixing and reaction may be carried out at 60 to 80° C. for 30 minutes to 3 hours, and the reaction of the main agent may be carried out at 60 to 80° C. for 2 minutes to 20 minutes.

The polyethylene-based oligomer includes poly(ethylene glycol) methyl ether acrylate, and the content of the polyethylene-based oligomer in the intermediate layer may be 4 to 25% by weight, 5 to 20% by weight, or 14 to 20% by weight.

The curing agent includes divinyl-terminated polydimethylsiloxane, and the curing agent may include a dimethyl, methyl hydrogen siloxane.

The free volume ratio of the intermediate layer is 0.17 to 0.27 or 0.18 to 0.3, and the contact angle of the intermediate layer may be 50 to 90 degrees or 50 to 70 degrees.

Hereinafter, the first coating layer will be described by way of example of a specific compound as follows.

As the PDMS, a Sylgard 184 elastomer kit may be used. It is composed of a main agent (base) containing a vinyl group (—CH═CH₂) and a curing agent (cross-linker) containing a hydrosilyl group (—SiH), and is shown in Chemical Formulae 1 and 2. A polymer formed through thermal crosslinking by mixing PDMS, PEGMEA shown in Chemical Formula 3, and a Pt catalyst (Karstedt's catalyst) is as shown in Chemical Formula 4.

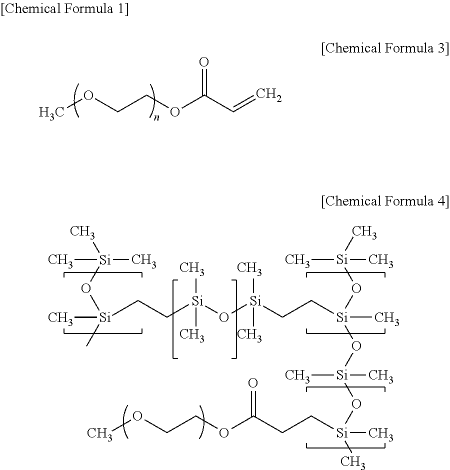

Chemical Formula 1: n is 60 to 70, and the molecular weight is 4600 to 5200 g/mol.

Chemical Formula 2: n and m are independently 1 to 10, and the molecular weight is about 1500 g/mol.

Chemical Formula 3: n is 1 to 9, and the molecular weight is 130 to 480 g/mol. Hydrophilic PDMS-PEG, which is crosslinked by a hydrosilylation reaction, can be prepared by mixing a main agent and a curing agent of PDMS with PEGMEA, which is a polyethylene-series oligomer including a vinyl group (—CH═CH₂).

In the formation of the selective layer, first, a second coating layer is formed on the selective layer.

Thereafter, the second coating layer is swollen. In the swelling, the second coating layer is swollen by applying, to the second coating layer, a second swelling agent including ethanol. The second swelling agent may be supplied to the first coating layer in a state containing air or saturated with air.

The swelling of the second coating layer may be carried out, without being limited thereto, at 10° C. to 30° C. or at room temperature, for 1 hour to 24 hours.

After the swelling, crosslinking of the swollen second coating layer is carried out. In the crosslinking, drying is also performed. Through the crosslinking, the selective layer is formed.

The crosslinking may be performed at 70° C. to 90° C. for 5 hours to 24 hours.

The selective layer, based on the total weight of components (A) and (B), may include (A) 30 to 90% by weight of a polyether-based copolymer; and (B) 10 to 70% by weight of a polyether.

The polyether-based copolymer includes polyetheramide, and the polyether-based copolymer may include a polyethylene-based oligomer including a vinyl group.

In the selective layer, the polyether-based copolymer (A) may act as a matrix, and the polyether (B) may act as a dispersed phase.

In the present invention, a selective layer having high permeability and high selectivity for carbon dioxide can be prepared using a polyether block amide (Pebax® 1657, Arkema) Pebax and PEGMEA, and the selective layer can be represented by Chemical Formula 5.

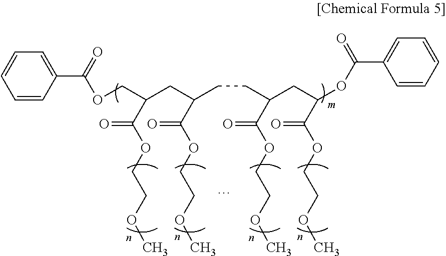

Chemical Formula 5: n is 8 to 9, and m is 4 to 112.

The intermediate layer modified to be hydrophilic exhibits relatively good interaction with the hydrophilic selective layer. In addition, when drying the modified PDMS intermediate layer using an air gas including hexane, formation of a defect-free, highly permeable intermediate layer can be realized with high reproducibility. Likewise, when drying the selective layer using an air gas including ethanol, formation of a selective layer having excellent selectivity can be realized with high reproducibility.

The polymer hollow fiber membrane of the present invention is manufactured by coating a bore surface of a hollow fiber-type support, and is suitable for producing a large-area hollow fiber membrane module without damage to the selective layer.

The polymer hollow fiber membrane according to the present invention can be used in a method for separating a gas, in which a mixed gas including carbon dioxide is passed through the polymer hollow fiber membrane to remove at least a portion of the carbon dioxide.

The mixed gas may be selected from the group consisting of carbon dioxide/nitrogen, carbon dioxide/carbon monoxide, carbon dioxide/oxygen, carbon dioxide/methane, and carbon dioxide/hydrogen.

When the porous polymer support is in the form of a hollow fiber membrane, the carbon dioxide permeability of the intermediate layer may be 168±37 GPU, 168±15 GPU, or 168±50 GPU, the carbon dioxide/nitrogen selectivity may be 8.7±0.8, 8.7±1.5, or 8.7±0.4, and the carbon dioxide/oxygen selectivity may be 4.4±0.4, 4.4±1.0, or 4.4±0.2.

When the porous polymer support is in the form of a hollow fiber membrane, the carbon dioxide permeability of the polymer hollow fiber membrane may be 138±34 GPU, 138±50 GPU or 138±15G PU, the carbon dioxide/nitrogen selectivity may be 23.4±4.1, 23.4±6.0 or 23.4±2.0, and the carbon dioxide/oxygen selectivity may be 13.1±1.8, 13.1±3.0 or 13.1±0.8.

When the porous polymer support is in the form of a flat sheet, the carbon dioxide permeability of the intermediate layer may be 286±30 GPU, 286±20 GPU, or 286±10 GPU, the carbon dioxide/nitrogen selectivity may be 29.8±5.0, 29.8±4.0, or 29.8±3.0, and the carbon dioxide/oxygen selectivity may be 14.3±3.0, 14.3±2.0, or 14.3±1.0.

### EXAMPLES

Hereinafter, the present invention will be described in more detail with reference to Examples and the like.

The compounds used in the following Examples and Comparative Examples are as follows.
Polydimethylsiloxane (Sylgard 184, Dow Corning)
Polyether oligomer containing a vinyl group (PEGMEA, Sigma Aldrich)
Karstedt's catalyst (Sigma Aldrich)
Polyether block amide (Pebax® 1657, Arkema)
Benzoyl peroxide (BPO, Sigma Aldrich)

### Comparative Example 1

The base and curing agent of Sylgard 184 were mixed at a weight ratio of 3:2 and Karstedt's catalyst was introduced to prepare a solution having 20 ppm of Pt. The prepared mixed solution was mixed at room temperature for 3 minutes and then crosslinked in an oil bath at 70° C. for 3 minutes. Hexane and ethanol were added to the partially crosslinked solution at a ratio of 70/30 to prepare a 15 wt % intermediate layer coating solution. The solution was poured into a Teflon dish and dried at room temperature for 2 days, and then crosslinked in an oven at 70° C. for 24 hours to obtain a PDMS separation membrane.

### Example 1

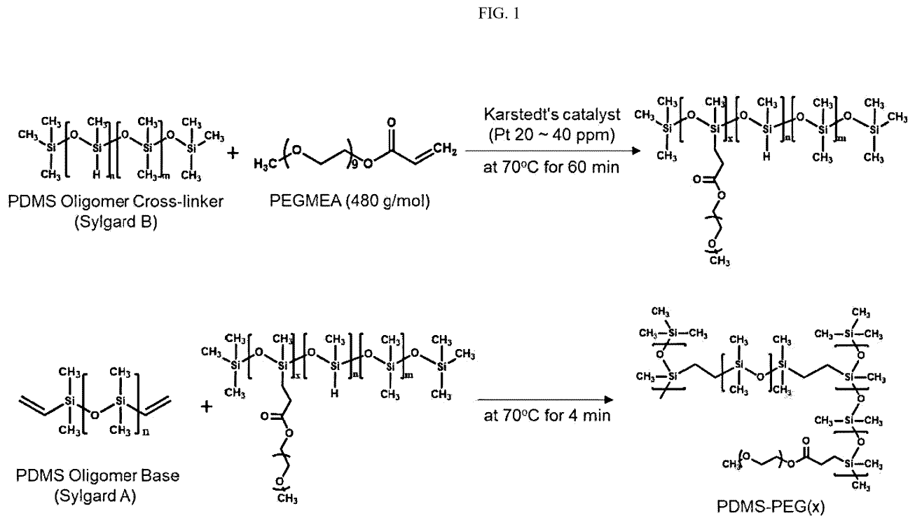

A PEGMEA solution having 20 or 40 ppm of Pt was prepared by introducing Karstedt's catalyst into PEGMEA. The curing agent of Sylgard 184 and PEGMEA (Pt) were mixed at weight ratios of 2:1, 2:2, and 2:3, mixed at room temperature for 3 minutes, and then crosslinked in an oil bath at 70° C. for 40 to 70 minutes. The base was added to the crosslinked solution such that the weight ratio of the base to the curing agent of Sylgard 184 became 3:2. The mixed solution was mixed at room temperature for 1 minute and then crosslinked in an oil bath at 70° C. for 4 minutes (Table 1). An intermediate layer coating solution of 15 wt % and 40 wt % was prepared by adding hexane and ethanol to the partially crosslinked solution at a ratio of 70/30. The reaction scheme is shown in FIG. 1, and the prepared crosslinked polymer is denoted as PDMS-PEG (x), where x is the concentration of crosslinked PEGMEA. A 15 wt % PDMS-PEG (x) solution was poured into a Teflon dish, dried at room temperature for 2 days, and then crosslinked in an oven at 80° C. for 24 hours to obtain a PDMS-PEG separation membrane. Thereafter, in order to remove unreacted materials, the membrane was immersed in hexane and ethanol, respectively, for 1 hour each, and finally vacuum-dried in an oven at 80° C. for 12 hours to obtain a final separation membrane.

TABLE 1

| | Weight (wt/wt) | | | | Reaction time at 70° C. | |
|---|---|---|---|---|---|---|
| | | Cross- | | | (min) | |
| Sample | Base | linker | PEGMEA | Pt (ppm) | 1-step | 2-step |
| PDMS-PEG(5.7) | 3 | 2 | 1 | 20 | 60 | 15 |
| PDMS-PEG(6.7) | 3 | 2 | 1 | 40 | 40 | 4 |
| PDMS-PEG(16.5) | 3 | 2 | 2 | 40 | 60 | 4 |

### Example 2

PDMS and PDMS-PEG (x) separation membranes were obtained in the same manner as in Comparative Example 1 and Example 1. At room temperature, the separation membranes were placed in a glove bag saturated with a hexane solution so as to be swollen in hexane. After 24 hours, the separation membranes swollen in hexane were vacuum-dried in an oven at 80° C. for 12 hours to obtain separation membranes.

### Comparative Example 2

A solution was prepared by mixing ethanol and water at a weight ratio of 70:30. Pebax was added to the prepared mixed solution in an amount of 3 wt %, and dissolved in an oil bath at 80° C. for one day to prepare a selective layer coating solution.

### Example 3

A 3 wt % Pebax solution was prepared in the same manner as in Comparative Example 1. PEGMEA was added to the Pebax solution such that the weight ratio of Pebax:PEGMEA became 30:70, respectively, and then BPO was added such that the molar ratio of PEGMEA:BPO became 100:1. The resulting solution was stirred at room temperature for 2 hours. After all components were dissolved, radical polymerization was carried out in an oil bath at 80° C. for 24 hours to prepare a selective layer coating solution. The obtained solution was designated as Pebax-PPEGMEA.

### Example 4

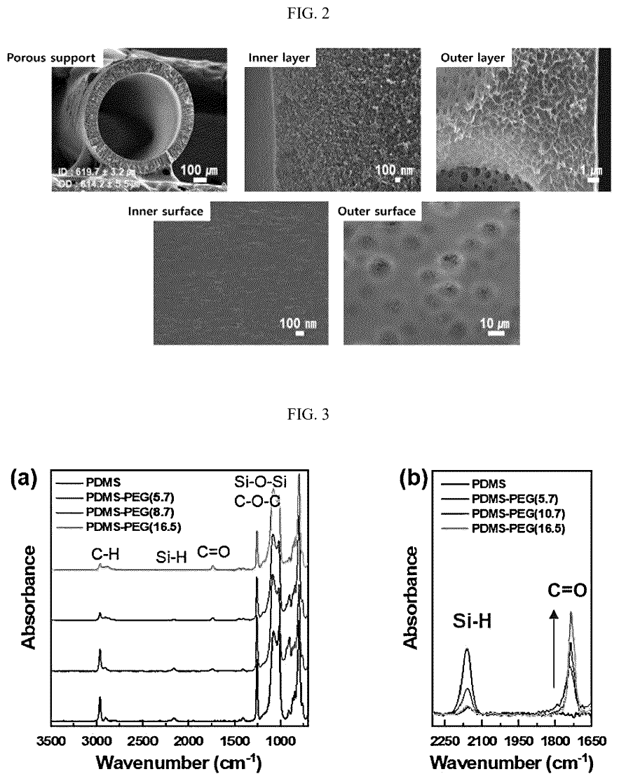

The polyetherimide (PEI) hollow fiber, which is a porous support used in the coating process, has inner and outer diameters of 671±3.2 μm and 878±5.5 μm, respectively, and internal pores are formed to be about 100 nm, as shown in FIG. 2. A hollow fiber module was fabricated using one strand thereof and used in an inner coating process.

The 15 wt % and 40 wt % intermediate layer coating solutions were passed through the hollow fiber module at a rate of 1 ml/min for 30 seconds using a syringe pump (isco pump). With a holding time of 60 seconds, air was then passed at a rate of 10 ml/min for 60 seconds to remove the solution remaining inside the hollow fiber. The coated hollow fiber module was dried at room temperature for 1 hour and then heat-cured and dried in an oven at 80° C. for 24 hours.

### Example 5

In the same manner as in Example 4, a 40 wt % intermediate layer coating solution was passed through the hollow fiber module at a rate of 10 ml/min for 3 minutes using a syringe pump. Hexane-saturated air was then passed at a rate of 10 ml/min for 3 hours. The coated hollow fiber module was heat-cured and dried in an oven at 80° C. for 24 hours. A selective layer was coated on the hollow fiber membrane having the intermediate layer formed thereon in the same manner as described above, ethanol-saturated air was passed at a rate of 10 ml/min for 3 hours, and then drying was carried out in an oven at 80° C. for 24 hours.

### Experimental Example 1

FTIR of the PDMS and PDMS-PEG (x) separation membranes obtained in Comparative Example 1 and Example 1 was measured, and the results are shown in (a) of FIG. 3. In the PDMS separation membrane, a Si—CH₃ bond appeared at 795 cm⁻¹ and 1,260 cm⁻¹, a Si—O—Si bond appeared at 1,150 to 1,000 cm⁻¹, and a Si—H bond appeared at 2,160 cm⁻¹. The —C═O bond present in PEGMEA appeared at 1,730 cm⁻¹, and the C—O—C bond was observed at 1,150 to 1,000 cm⁻¹. In (b) of FIG. 3, the Si—H bond at 2, 160 cm⁻¹ present in PDMS appears, and the —C═O bond present in PEGMEA is observed at 1,730 cm⁻¹. As the concentration of PEGMEA increases, the intensity of the −C═O peak increases, from which it can be seen that a crosslinked PDMS-PEG polymer is formed.

### Experimental Example 2

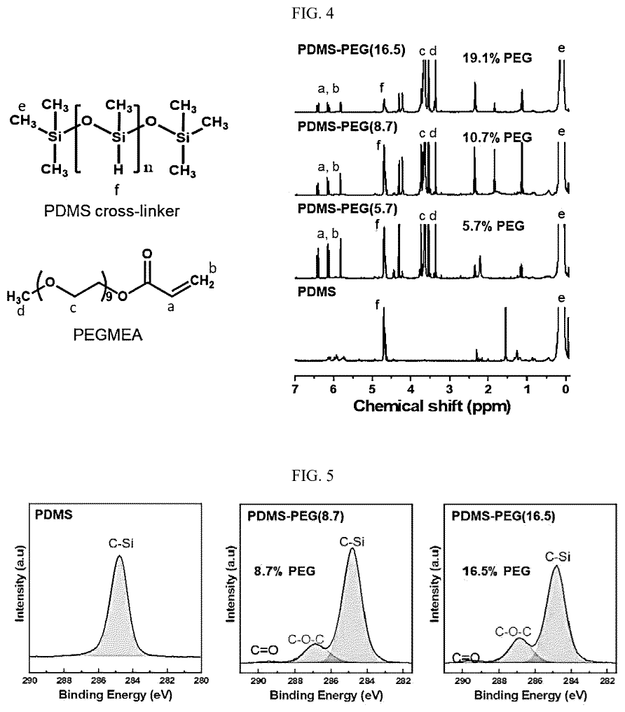

To confirm the degree of crosslinking between the PDMS cross-linker and PEGMEA, 1H-NMR analysis was performed on the reaction solution after the synthesis step in the first stage, and this is shown in FIG. 4. In the PDMS cross-linker, Si—CH₃ appeared at 0-0.5 ppm (e), and Si—H appeared at 4.6-4.8 ppm (d). In PDMS-PEG containing PEGMEA, new peaks appeared at 6-6.5 ppm (a, b), 3.5-3.9 ppm (c), and 3.3-3.4 ppm (d), which represent CH═CH₂, C—O—C, and —OCH₃, respectively.

The conversion rate of CH═CH in PEGMEA was calculated from the relative area change of CH═CH₂ (a, b) on the basis of the area of the —OCH₃ peak. Specifically, the conversion rate of CH═CH₂ of PEGMEA was calculated by Mathematical Formula 1 below.

$$Conversion ( \% ) = ( {A}_{d} - {A}_{a , b} ) / {A}_{d} \times 100 \qquad [ Mathematical Formula 1 ]$$

Specifically, the degree of crosslinking of PEGMEA was obtained by Mathematical Formula 2 below.

$$PEGMEA degree of crosslinking ( \% ) = \backslash [ AutoRightMatch ] PEG wt / ( PDMS cross - linker + PDMS base + PEG wt ) \times PEGMEA conversion ( \% ) \qquad [ Mathematical Formula 2 ]$$

TABLE 2

| | Conversion ratio of | Concentration of |
|---|---|---|
| Sample | PEGMEA at 1-step | grafting PEGMEA (%) |
| PDMS-PEG(5.7) | 64.3 | 5.7 |
| PDMS-PEG(8.7) | 66.7 | 10.7 |
| PDMS-PEG(16.5) | 55.7 | 19.1 |

In the PDMS-PEG separation membrane, as the concentration of Pt increased from 20 ppm to 40 ppm, the concentration of crosslinked PEGMEA increased from 5.7 to 10.7%. In addition, it can be seen that 19.1% of PEGMEA was crosslinked as the concentration of PEGMEA increased.

### Experimental Example 3

XPS analysis was performed in order to confirm the structure and degree of crosslinking of the PDMS membrane and the PDMS-PEG (8.7) and PDMS-PEG (16.5) separation membranes into which 40 ppm of Pt was introduced, and the results are shown in FIG. 5.

The C—Si bond of PDMS was detected in the range of 287 to 282 eV, the C═O bond of PEGMEA was detected in the range of 295 to 289 eV, and the C—O—C bond was detected in the range of 288 to 286 eV. As a result of calculating the concentration of PEGMEA from the areas of the C—O and C—Si peaks, it was confirmed that the PEGMEA concentrations of PDMS-PEG (8.7) and PDMS-PEG (16.5) were 8.7% and 16.5%, respectively. It was confirmed that PEGMEA was contained in a concentration similar to the result of the 1H-NMR analysis.

### Experimental Example 4

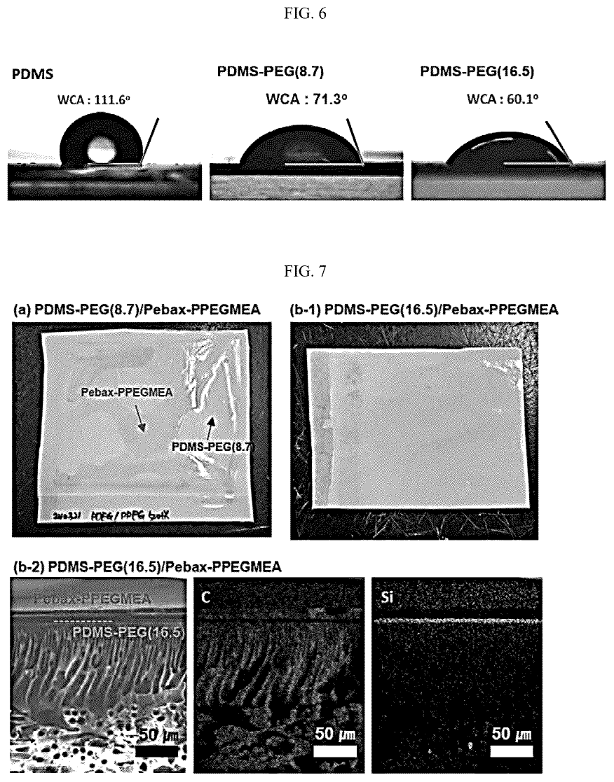

A water contact angle experiment was performed on the PDMS and the PDMS-PEG separation membranes into which 40 ppm of Pt was introduced, and the results are shown in FIG. 6. The contact angle of hydrophobic PDMS is 111.6°, and those of PDMS-PEG (8.7) and PDMS-PEG (16.5) decrease to 71.3° and 60.1°, respectively, thereby confirming that hydrophilicity is improved as PEG is introduced. It was confirmed that the hydrophilicity-improved PDMS-PEG intermediate layer exhibits improved interaction with the hydrophilic PEI support and the Pebax-PPEGMEA selective layer (FIG. 7). In PDMS-PEG (8.7), the wettability of the Pebax-PPEGMEA selective layer is poor, so that uniform coating is not achieved, but in hydrophilicity-improved PDMS-PEG (16.5), Pebax-PPEGMEA was confirmed to be uniformly coated.

### Experimental Example 5

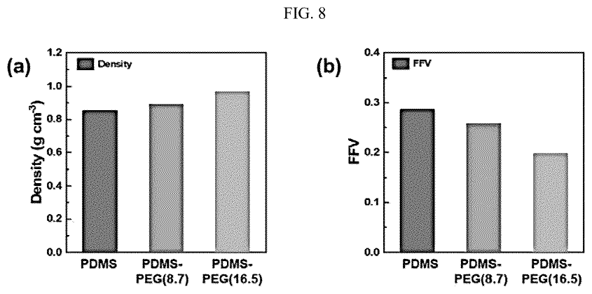

In order to confirm the fractional free volume (FFV) of the prepared separation membranes, the densities of all the separation membranes were measured and the FFV was calculated using the measured densities. As shown in FIG. 8, the PDMS-PEG separation membrane exhibited a higher density than PDMS, whereas the FFV was found to decrease. More specifically, the FFV of PDMS was 0.29, and the FFVs of PDMS-PEG (8.7) and PDMS-PEG (16.5) were confirmed to be 0.26 and 0.20, respectively. From this, it can be seen that the FFV decreases as PEGMEA is introduced into PDMS.

### Experimental Example 6

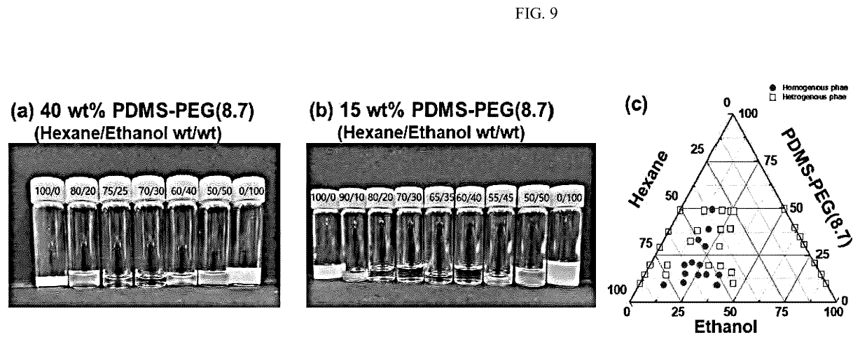

In order to prepare the prepared PDMS-PEG as a coating solution, the solubility thereof with respect to a solvent was examined. It was confirmed that PDMS-PEG is not completely dissolved in hexane, which is due to the low solubility of PEG in hexane. Therefore, an experiment was carried out to improve the solubility by adding ethanol. 40 wt % and 15 wt % PDMS-PEG (8.7) solutions were prepared, and experiments were carried out by adjusting the weight ratio of hexane and ethanol to 100/0, 80/20, 75/25, 70/30, 65/35, 60/40, 50/50, and 0/100. As shown in (a) and (b) of FIG. 9, in the case of the 40 wt % PDMS-PEG (8.7) solution, PDMS-PEG was completely dissolved when the hexane/ethanol ratio was 75/25 to 70/30 wt/wt, and in the case of the 15 wt % PDMS-PEG (8.7) solution, it was completely dissolved when the hexane/ethanol ratio was 80/20 to 60/40 wt/wt. The change in solubility according to the hexane/ethanol composition at various PDMS-PEG (8.7) concentrations was shown as a ternary phase diagram in (c) of FIG. 9, and it was confirmed that differences in solubility for PDMS-PEG (8.7) polymers of different concentrations appear depending on the solvent composition.

### Experimental Example 7

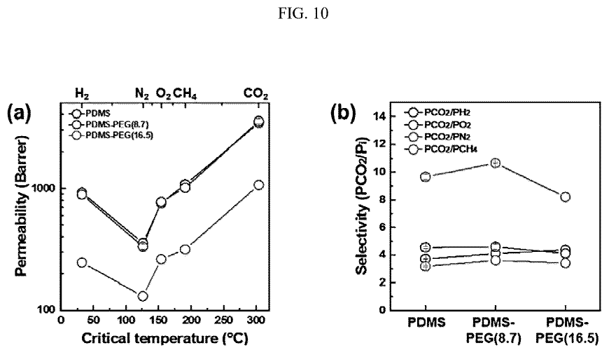

For the separation membranes prepared in the Examples, gas permeabilities for single gas components of hydrogen (H₂), carbon dioxide (CO₂), oxygen (O₂), nitrogen (N₂), and methane (CH₄) were measured under conditions of 1 atm and 35° C., and CO₂/H₂, CO₂/N₂, CO₂/O₂, and CO₂/CH₄ selectivities corresponding thereto were shown. The results are presented in Tables 3 and 4 and in FIG. 10.

In all separation membranes, the gas permeability decreased in the order of CO₂>>CH₄>H₂>O₂>N₂. This is because, as a characteristic of rubbery polymers, the higher the condensability, the higher the gas permeability appears. H₂ (2.89 Å) exhibited relatively high permeation properties because it has a lower kinetic diameter than N₂ (3.64 Å).

The CO₂ permeability of PDMS-PEG (16.5) was 1073 Barrer and the CO₂/O₂ selectivity was 4.1. Although the CO₂ permeability decreased by 68.8% compared with the PDMS membrane, it was confirmed that all gas selectivities with respect to CO₂ were maintained. The CO₂ permeability of hydrophilic PEGMEA is known to be 570 Barrer (J. Membr. Sci., 276 (2006) 145-161). Accordingly, it can be seen that the permeability decreases when high-permeability PDMS and PEGMEA are introduced. This result is consistent with the FFV tendency mentioned in FIG. 8 above.

TABLE 3

| | Permeability | | | | |
|---|---|---|---|---|---|
| | (Barrer = 10⁻¹⁰ cm cm³(STP)cm⁻² cmHg⁻¹ s⁻¹) | | | | |
| Sample | H₂ | CO₂ | O₂ | N₂ | CH₄ |
| PDMS | 928.1 ± 58.9 | 3437.7 ± 186.6 | 755.6 ± 29.8 | 355.4 ± 12.3 | 1083.2 ± 43.0 |
| PDMS-PEG(8.7) | 894.6 | 3549.7 ± 165.7 | 777.2 ± 65.5 | 332.8 ± 17.0 | 1018.0 |
| PDMS-PEG(16.5) | 245.7 | 1073.1 | 261.3 | 130.8 | 314.9 |

TABLE 4

| | Selectivity (—) | | | |
|---|---|---|---|---|
| Sample | CO₂/H₂ | CO₂/O₂ | CO₂/N₂ | CO₂/CH₄ |
| PDMS | 3.7 ± 0.03 | 4.5 ± 0.1 | 0.7 ± 0.2 | 3.2 ± 0.1 |
| PDMS-PEG(8.7) | 4.1 | 4.6 ± 0.2 | 10.7 ± 0.1 | 3.6 |
| PDMS-PEG(16.5) | 4.4 | 4.1 | 8.2 | 3.4 |

### Experimental Example 8

In order to improve the relatively low permeability of PDMS-PEG (16.5) compared with PDMS, a post-treatment process of swelling the prepared separation membrane in hexane was carried out. The results are shown in Table 5. While it was confirmed that the CO₂ permeability of PDMS was 3464 Barrer, similar to the previous value, the CO₂ permeability of PDMS-PEG (16.5) was 2827 Barrer, improved by 144.5%, and it was confirmed that the gas selectivity was maintained at this time. Accordingly, in the present study, a coating process using PDMS-PEG (16.5) and a post-treatment process for improving permeability were introduced, and Pebax-PPEGMEA selective layer coating was carried out.

TABLE 5

| | Permeability | | | | |
|---|---|---|---|---|---|
| | (Barrer = 10⁻¹⁰ cm cm³(STP)cm⁻² cmHg⁻¹ s⁻¹) | | | Selectivity (—) | |
| Sample | CO₂ | O₂ | N₂ | CO₂/O₂ | CO₂/N₂ |
| PDMS | 3438 ± 187 | 756 ± 30 | 355 ± 12 | 4.5 ± 0.1 | 9.7 ± 0.2 |
| PDMS-PEG(16.5) | 1073 | 261 | 131 | 4.1 | 8.2 |
| Post treatment of | 3464 | 777 | 304 | 4.5 | 11.4 |
| PDMS | | | | | |
| Post treatment of | 2827 | 470 | 373 | 5.9 | 7.6 |
| PDMS-PEG(16.5) | | | | | |

### Experimental Example 9

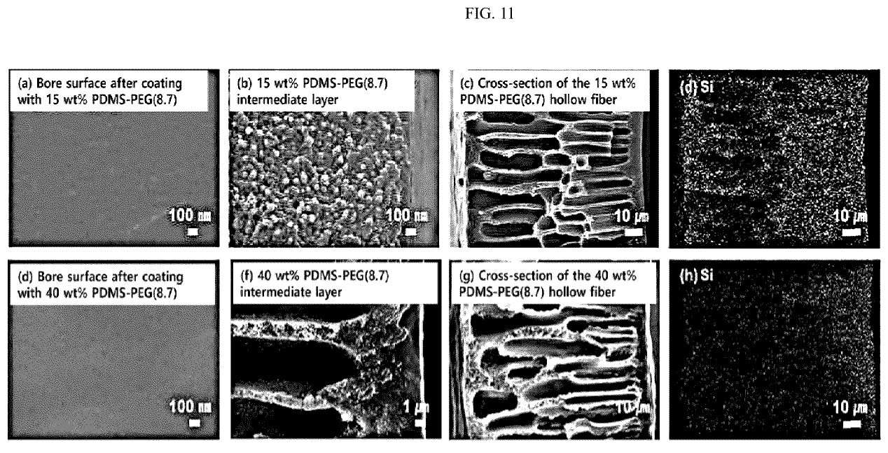

In order to form an intermediate layer inside the above support, 15 wt % and 40 wt % PDMS-PEG (8.7) coating solutions were prepared as in Example 4, and these were coated through a flow process. In the EDS images, it was confirmed that, as the viscosity of the coating solution increased from 15 wt % to 40 wt %, penetration of the PDMS-PEG (8.7) solution into the inside of the support decreased ((d) and (h) of FIG. 11). However, the CO₂ permeability greatly decreased from 480±59 GPU to 251±16 GPU (Table 6). This is considered to be because, as the concentration of PDMS-PEG (8.7) increased, it did not penetrate into the inside of the support, but a thick intermediate layer was formed. As a result of calculating the theoretical selective layer coating thickness of the hollow fiber membrane using the N₂ permeability of the dense membrane of PDMS-PEG (8.7), it is considered that a 40 wt % PDMS-PEG (8.7) selective layer having a thickness of 10.1 μm was coated. In order to minimize penetration into the inside of the support, coating was carried out using a PDMS-PEG solution having a high concentration.

TABLE 6

| PDMS-PEG(6.7) | | | | | | | |
|---|---|---|---|---|---|---|---|
| solution | | Permeance | | | | | Theoretical |
| concentration | Viscosity | (GPU = 10⁻⁶ cm³(STP)cm⁻² cmHg⁻¹ s⁻¹) | | | Selectivity (−) | | thickness |
| (wt %) | (mPa · s) | CO₂ | O₂ | N₂ | CO₂/O₂ | CO₂/N₂ | (μm) |
| 40 | 62.3 | 251 ± 16 | 63 ± 10 | 33 ± 6 | 4.0 ± 0.4 | 7.5 ± 0.8 | 10.1 |
| 15 | 1.6 | 480 ± 59 | 95 ± 18 | 50 ± 9 | 4.6 ± 0.3 | 8.7 ± 0.7 | 6.7 |

### Experimental Example 10

A 40 wt % PDMS-PEG (16.5) coating solution was prepared and coated by a flow process, and when the hollow fiber membrane was dried with air saturated with hexane, the CO₂ permeability was 168±37 GPU and the CO₂/O₂ selectivity was 4.4±0.4, and the CO₂ permeability increased by 61% compared to when dried with air. These results showed the same tendency as the permeability improvement of the dense membrane in the previous study. Accordingly, it was confirmed that, when drying the hollow fiber coated with air saturated with hexane, PDMS is swollen by hexane and the permeability is improved. Along with the improvement in permeability, it was confirmed that the CO₂/O₂ and CO₂/N₂ selectivities were similar to the flat membrane results, and through this, it was confirmed that a defect-free intermediate layer coating is possible by swelling of the PDMS-PEG (16.5) polymer by hexane.

TABLE 7

| | Permeance | | | | |
|---|---|---|---|---|---|
| PDMS-PEG(16.5) | (GPU = 10⁻⁶ cm³(STP)cm⁻² cmHg⁻¹ s⁻¹) | | | Selectivity (—) | |
| dry conditions | CO₂ | O₂ | N₂ | CO₂/O₂ | CO₂/N₂ |
| Without post-treatment | 104 ± 27 | 28 ± 5 | 16 ± 3 | 3.8 ± 0.3 | 6.3 ± 0.4 |
| With post-treatmen | 168 ± 37 | 39 ± 11 | 19 ± 5 | 4.4 ± 0.4 | 8.7 ± 0.8 |

### Experimental Example 11

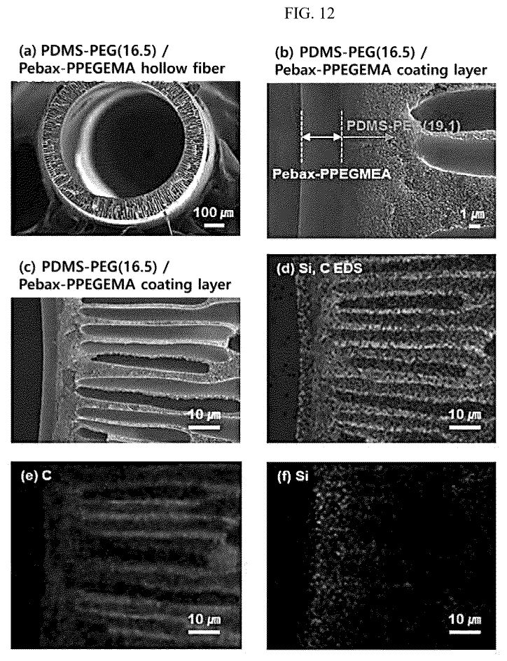

The gas permeability results of the hollow fiber membrane, in which the inner bore surface of a porous PEI hollow fiber support was coated with a 40 wt % PDMS-PEG (16.5) coating solution and then a Pebax-PPEGMEA selective layer was coated thereon, are shown in Table 8. The hollow fiber membrane exhibited a CO₂ permeability of 138±34 GPU, and CO₂/O₂ and CO₂/N₂ selectivities of 13.1±1.8 and 23.4±4.1, respectively. Although it showed relatively lower selectivities than the CO₂/O₂ (17.1) and CO₂/N₂ (46.7) selectivities of the Pebax-PPEGMEA dense membrane, it was confirmed that fabrication of a Pebax hollow fiber membrane with excellent reproducibility (greater than 70%) is possible due to swelling of the PDMS-PEG (16.5) intermediate layer by hexane and swelling of the Pebax/PPEGMEA selective layer by ethanol. From the SEM image and EDS analysis results (FIG. 12) of the coated hollow fiber membrane, it was confirmed that the Pebax-PPEGMEA selective layer and the PDMS-PEG (16.5) intermediate layer were coated with thicknesses of about 4 μm and 10 μm, respectively.

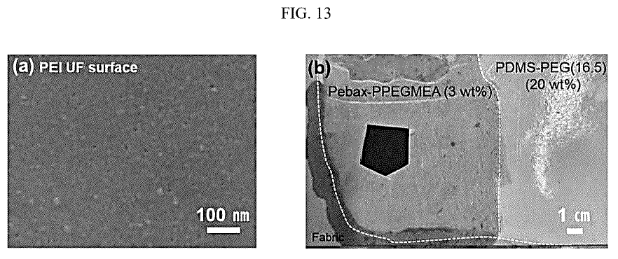

In addition, PDMS-PEG (16.5) and Pebax-PPEGMEA were coated on a flat-sheet PEI support (CO₂ permeability: 9100 GPU, CO₂/N₂ selectivity: 0.9, pore size: about 10 nm). As shown in (b) of FIG. 13, it can be confirmed that Pebax-PPEGMEA (blue) is uniformly coated on PDMS-PEG (16.5). At this time, a CO₂ permeability of 286 GPU and CO₂/O₂ and CO₂/N₂ selectivities of 14.3 and 29.8, respectively, exhibited excellent performance (Table 8 and FIG. 13).

TABLE 8

| | Permeance | | | | |
|---|---|---|---|---|---|
| | (GPU = 10⁻⁶ cm³(STP)cm⁻² cmHg⁻¹ s⁻¹) | | | Selectivity(—) | |
| Sample | CO2 | O2 | N2 | CO2/O2 | CO2/N2 |
| PDMS-PEG(16.5) | 168 ± 37 | 39 ± 11 | 19 ± 5 | 4.4 ± 0.4 | 8.7 ± 0.8 |
| (Hollow fiber) | | | | | |
| +Pebax-PPEGMEA | 138 ± 34 | 11 ± 4 | 6 ± 3 | 13.1 ± 1.8 | 23.4 ± 4.1 |
| (Hollow fiber) | | | | | |
| +Pebax-PPEGMEA | 286 | 20 | 10 | 14.3 | 29.8 |
| (Flat sheet membrane) | | | | | |
| Pebax-PPEGMEA | 1388.3 ± 3.0 | 78.7 | 29.8 ± 2.4 | 17.1 | 46.7 ± 0.6 |
| (Dense membrane) | | | | | |

### Experimental Example 12

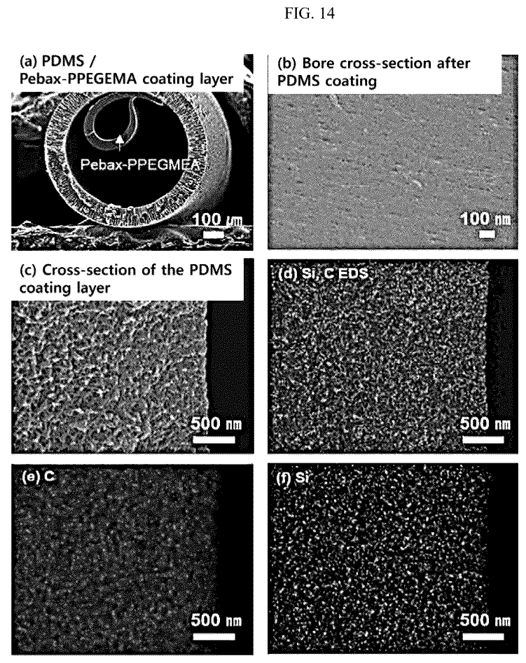

In order to confirm the mutual relationship according to the polymer materials of the intermediate layer and the selective layer, an experiment was carried out in which the intermediate layer was coated with PDMS and then the selective layer was coated, and the results are shown in Table 9. In the PDMS/Pebax-PPEGMEA separation membrane, the CO₂/O₂ and CO₂/N₂ selectivities were measured to be 4.0 and 8.4, respectively, which are lower selectivities than those of the Pebax-PPEGMEA dense membrane. As a result of SEM analysis, in the case where Pebax-PPEGMEA was coated as a selective layer on the surface of the PDMS intermediate layer, it was confirmed that the Pebax-PPEGMEA selective layer was peeled off (FIG. 14). These results are considered to be because the wettability of hydrophilic Pebax-PPEGMEA with respect to the hydrophobic PDMS surface is poor. In addition, it was confirmed by SEM that hydrophobic PDMS has low wettability with PEI, which is the support, and that defects are present.

TABLE 9

| | Permeance | | | | |
|---|---|---|---|---|---|
| | (GPU = 10⁻⁶ cm³(STP)cm⁻² cmHg⁻¹ s⁻¹) | | | Selectivity (—) | |
| Sample | CO₂ | O₂ | N₂ | CO₂/O₂ | CO₂/N₂ |
| PDMS/Pebax-PPEGMEA | 160 | 41 | 19 | 3.9 | 8.4 |
| PDMS-PEG(16.5)/Pebax- | 138 ± 34 | 11 ± 4 | 6 ± 3 | 13.1 ± 1.8 | 23.4 ± 4.1 |
| PPEGMEA | | | | | |
| Pebax-PPEGMEA | 1388.3 ± 3.0 | 78.7 | 29.8 ± 2.4 | 17.1 | 46.7 ± 0.6 |
| (Dense membrane) | | | | | |

What is claimed is:

1. An asymmetric polymer separation membrane having high selectivity for carbon dioxide, comprising:
a porous polymer support layer;
an intermediate layer formed on the porous polymer support layer; and
a selective layer formed on a surface of the intermediate layer,
wherein the intermediate layer is modified to be hydrophilic, and
wherein the selective layer is hydrophilic.

2. The separation membrane according to claim 1,
wherein the intermediate layer is a crosslinked structure of a polyethylene-based oligomer containing a vinyl group and PDMS.

3. The separation membrane according to claim 2,
wherein the polyethylene-based oligomer includes poly(ethylene glycol) methyl ether acrylate.

4. The separation membrane according to claim 3,
wherein the content of the polyethylene-based oligomer in the intermediate layer is 14 to 20% by weight.

5. The separation membrane according to claim 4,
wherein the intermediate layer is obtained through a crosslinking reaction after being swollen by a first swelling agent comprising at least one selected from ethanol, methanol, and hexane with respect to the intermediate coating layer.

6. The separation membrane according to claim 5,
wherein a free volume ratio of the intermediate layer is 0.18 to 0.3, and a contact angle of the intermediate layer is 50 to 70 degrees.

7. The separation membrane according to claim 5,
wherein the porous polymer support layer has a hollow, the intermediate layer and the selective layer are formed on an inner surface of the hollow, and a carbon dioxide permeability of the intermediate layer is 168±37 GPU, a carbon dioxide/nitrogen selectivity is 8.7±0.8, and a carbon dioxide/oxygen selectivity is 4.4±0.4, 4.4±1.0 or 4.4±0.2.

8. The separation membrane according to claim 4,
wherein the selective layer, based on a total weight of components (A) and (B), comprises: (A) 30 to 90% by weight of a polyether-based copolymer; and (B) 10 to 70% by weight of a polyether.

9. The separation membrane according to claim 8,
wherein the polyether-based copolymer includes a polyetheramide, and wherein the polyether-based copolymer includes a polyethylene-based oligomer containing a vinyl group.

10. The separation membrane according to claim 9,
wherein the polyether-based copolymer (A) acts as a matrix, and the polyether (B) acts as a dispersed phase.

11. The separation membrane according to claim 10,
wherein the selective layer is obtained through a crosslinking reaction after being swollen by a second swelling agent comprising ethanol with respect to the intermediate coating layer.

12. The separation membrane according to claim 10,
wherein the porous polymer support layer has a hollow, the intermediate layer and the selective layer are formed on an inner surface of the hollow, and a carbon dioxide permeability of the separation membrane is 138±34 GPU, a carbon dioxide/nitrogen selectivity is 23.4±4.1, and a carbon dioxide/oxygen selectivity is 13.1±1.8.

13. The separation membrane according to claim 10,
wherein the porous polymer support layer is in a flat-sheet form, the intermediate layer and the selective layer are formed on at least one surface of the porous polymer support layer,
and a carbon dioxide permeability of the intermediate layer is 286±20 GPU, a carbon dioxide/nitrogen selectivity is 29.8±4.0, and a carbon dioxide/oxygen selectivity is 14.3±2.0.

14. A method for producing an asymmetric polymer separation membrane having high selectivity for carbon dioxide, comprising:
a step of forming an intermediate layer on a porous polymer support layer; and
a step of forming a selective layer on the intermediate layer,
wherein the intermediate layer is modified to be hydrophilic, and wherein the selective layer is hydrophilic.

15. The method according to claim 14,
wherein the intermediate layer is formed by crosslinking a polyethylene-based oligomer and PDMS, and
wherein formation of the intermediate layer comprises:
preparing a first coating solution by preparing a mixture by mixing a curing agent containing a hydrosilyl group and the polyethylene-based oligomer, and adding a main agent containing a vinyl group to the mixture;
coating the first coating solution on an inner surface of a hollow to prepare a first coating layer; and
crosslinking the first coating layer.

16. The method according to claim 15,
wherein the polyethylene-based oligomer includes poly(ethylene glycol) methyl ether acrylate.

17. The method according to claim 16,
wherein, in the intermediate layer, the content of the polyethylene-based oligomer is 14 to 20% by weight.

18. The method according to claim 17,
wherein the curing agent includes divinyl-terminated polydimethylsiloxane, and wherein the curing agent includes a dimethyl, methyl hydrogen siloxane.

19. A method for separating a gas, comprising a step of passing a mixed gas comprising at least carbon dioxide through the separation membrane according to claim 1 to remove at least a portion of the carbon dioxide.

20. The method according to claim 19,
wherein the mixed gas is selected from the group consisting of carbon dioxide/nitrogen, carbon dioxide/carbon monoxide, carbon dioxide/oxygen, carbon dioxide/methane and carbon dioxide/hydrogen.
